(19) United States
(12) Patent Application Publication
(10) Pub. No.: US 2010/0112457 A1
(43) Pub. Date: May 6, 2010

(54) ELECTROCHEMICAL ENERGY SOURCE AND ELECTRONIC DEVICE PROVIDED WITH SUCH AN ELECTROCHEMICAL ENERGY SOURCE

(75) Inventors: Rogier Adrianus Henrica Niessen, Eindhoven (NL); Petrus Henricus Laurentius Notten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/593,303

(22) PCT Filed: Mar. 27, 2008
(86) PCT No.: PCT/IB08/51138

§ 371 Date: Sep. 28, 2009

(30) Foreign Application Priority Data
Apr. 2, 2007 (EP) 07105431.6

(51) Int. Cl. H01M 6/18; H01M 4/02; H01M 4/54

(52) U.S. Cl. 429/322; 429/209; 429/219

(57) ABSTRACT

Electrochemical energy sources based on solid-state electrolytes are known in the art. These (planar) energy sources, or solid-state batteries, efficiently convert chemical energy into electrical energy and can be used as the power sources for portable electronics. The invention relates to an improved electrochemical energy source. The invention also relates to an electronic device provided with such an electrochemical energy source.

### FIELD OF THE INVENTION

The invention relates to an improved electrochemical energy source. The invention also relates to an electronic device provided with such an electrochemical energy source.

### BACKGROUND OF THE INVENTION

Electrochemical energy sources based on solid-state electrolytes are known in the art. These (planar) energy sources, or ‘solid-state batteries’, efficiently convert chemical energy into electrical energy and can be used as the power sources for portable electronics. At small scale such batteries can be used to supply electrical energy to e.g. microelectronic modules, more particular to integrated circuits (IC's). An example hereof is disclosed in the international patent application WO 00/25378, where a solid-state thin-film micro battery is fabricated directly onto a specific substrate. During this fabrication process the first electrode, the intermediate solid-state electrolyte, and the second electrode are subsequently deposited as a stack onto the substrate. The substrate may be flat or curved to realise a two-dimensional or three-dimensional battery stack. A major drawback of the known batteries is that the volumetric energy density, and hence the performance of the known batteries is relatively poor.

It is an object of the invention to provide a relatively efficient electrochemical energy source.

### SUMMARY OF THE INVENTION

This object can be achieved by providing an electrochemical energy source according to the preamble, comprising: at least one cell is deposited onto a substrate, each cell comprising: a first electrode, a solid-state electrolyte deposited onto the first electrode, and a second electrode deposited onto the solid-state electrolyte; wherein at least a surface of the solid-state electrolyte facing the second electrode is patterned at least partially. In this manner the effective contact surface area between the electrolyte and the second electrode is increased substantially with respect to a conventional relatively smooth contact surface of the electrolyte, resulting in a proportional increase of the rate capability of the electrochemical energy source according to the invention. Patterning the (upper) surface of the electrolyte facing the second electrode (and prior to depositing the second electrode) can be realised by means of various methods, among others selective wet chemical etching, physical etching (Reactive Ion Etching), mechanical imprinting, and chemical mechanical polishing (CMP). After patterning the electrolyte the second electrode will be deposited on top of the patterned electrolyte. The first electrode commonly comprises a cathode, and the second electrode commonly comprises an anode (or vice versa). Each electrode commonly also comprises a current collector. By means of the current collectors the cell can easily be connected to an electronic device. Preferably, the current collectors are made of at least one of the following materials: Al, Ni, Pt, Au, Ag, Cu, Ta, Ti, TaN, and TiN. Other kinds of current collectors, such as, preferably doped, semiconductor materials such as e.g. Si, GaAs, InP may also be applied.

The pattern of the electrolyte to increase the contact surface area between the electrolyte can be shaped in various ways. Preferably, the patterned surface of the electrolyte is provided with multiple cavities, in particular pillars, trenches, slits, or holes, which particular cavities can be applied in a relatively accurate manner. In this manner the increased performance of the electrochemical energy source can also be predetermined in a relatively accurate manner. In this context it is noted that it has been found that it is commonly more effective and beneficial to pattern the electrolyte rather than merely one of the electrodes to realise an increased effective surface area. In case merely the first electrode would be patterned, it is expected that merely a liquid-state electrolyte (and hence not a solid-state electrolyte) could effectively be applied.

A surface of the solid-state electrolyte facing the first electrode may substantially be flat. However, it would also be conceivable that the first electrode is patterned and that the electrolyte is deposited on top of the patterned first electrode. After this deposition step the electrolyte will (further) be patterned prior to deposition of the second electrode. Hence, to further increase to rate capability of the electrochemical source, it may be advantageous to pattern the surface of the first electrode facing the electrolyte (prior to depositing the electrolyte). The patterned surface of the first electrode is preferably provided with multiple cavities, in particular pillars, trenches, slits, or holes.

In a preferred embodiment the cathode is made of at least one material selected from the group consisting of: LiCoO₂, LiMn₂O₄, LiFePO₄, V₂O₅, MoO₃, WO₃, and LiNiO₂. It is has been found that at least these materials are highly suitable to be applied in lithium ion energy sources and, moreover, these materials have a predefined optimum annealing temperature range or temperature range (cited above in parentheses), based upon which an optimum deposition order may be determined. Examples of a cathode in case of a proton based energy source are Ni(OH)₂ and NiM(OH)₂, wherein M is formed by one or more elements selected from the group of e.g. Cd, Co, or Bi. It may be clear that also other cathode materials may be used in the electrochemical energy source according to the invention. The anode is preferably made of at least one material selected from the group consisting of: Si, SnOₓ, Li₄Ti₅O₁₂, SiOₓ, LiSiON, LiSnON, and LiSiSnON, in particular LiₓSiSn_{0.87}O_{1.20}N_{1.72}. As the cathode materials, these materials are suitable to be applied in a lithium ion battery, and, moreover, have a predefined optimum annealing temperature or temperature range (cited above in parentheses). The solid-state electrolyte is made of at least one material selected from the group consisting of: Li₅La₃Ta₂O₁₂ (Garnet-type class), LiPON, LiNbO₃, LiTaO₃, and Li₉SiAlO₈. These solid-state electrolyte materials are suitable to be applied in lithium ion batteries, and have a known optimum annealing temperature (cited above in parentheses). Other solid-state electrolyte materials which may be applied smartly are lithium orthotungstate (Li₂WO₄), Lithium Germanium Oxynitride (LiGeON), Li₁₄ZnGe₄O₁₆ (lisicon), Li₃N, beta-aluminas, or Li_{1.3}Ti_{1.7}Al_{0.3}(PO₄)₃ (nasicon-type). A proton conducting electrolyte may for example be formed by TiO(OH), or ZrO₂Hₓ.

Preferably, at least one electrode of the energy source according to the invention is adapted for storage of active species of at least one of following elements: hydrogen (H), lithium (Li), beryllium (Be), magnesium (Mg), aluminium (Al), copper (Cu), silver (Ag), sodium (Na) and potassium (K), or any other suitable element which is assigned to group 1 or group 2 of the periodic table. So, the electrochemical energy source of the energy system according to the invention may be based on various intercalation mechanisms and is therefore suitable to form different kinds of (reserve-type) battery cells, e.g. Li-ion battery cells, NiMH battery cells, et cetera. In a preferred embodiment at least one electrode, more particularly the battery anode, comprises at least one of the following materials: C, Sn, Ge, Pb, Zn, Bi, Sb, Li, and, preferably doped, Si. A combination of these materials may also be used to form the electrode(s). Preferably, n-type or p-type doped Si is used as electrode, or a doped Si-related compound, like SiGe or SiGeC. Also other suitable materials may be applied as anode, preferably any other suitable element which is assigned to one of groups 12-16 of the periodic table, provided that the material of the battery electrode is adapted for intercalation and storing of the abovementioned reactive species. The aforementioned materials are in particularly suitable to be applied in lithium ion based battery cells. In case a hydrogen based battery cell is applied, the anode preferably comprises a hydride forming material, such as AB₅-type materials, in particular LaNi₅, and such as magnesium-based alloys, in particular MgₓTi₁₋ₓ.

In a preferred embodiment at least one electrode of the first electrode and the second electrode is patterned at least partially. By patterning or structuring one, and preferably both, electrodes of the electrochemical energy source according to the invention, a three-dimensional surface area, and hence an increased surface area per footprint of the electrode(s), and an increased contact surface per volume between the at least one electrode and the electrolytic stack is obtained. This increase of the contact surface(s) leads to an improved rate capability of the energy source, and hence to an increased performance of the energy source according to the invention. In this way the power density in the energy source may be maximized and thus optimized. Due to this increased cell performance a small-scale energy source according to the invention will be adapted for powering a small-scale electronic device in a satisfying manner. Moreover, due to this increased performance, the freedom of choice of (small-scale) electronic components to be powered by the electrochemical energy source according to the invention will be increased substantially. The nature, shape, and dimensioning of the pattern may be various, as will be elucidated below. It is preferred that at least one surface of at least one electrode is substantially regularly patterned, and more preferably that the applied pattern is provided with one or more cavities, in particular pillars, trenches, slits, or holes, which particular cavities can be applied in a relatively accurate manner. In this manner the increased performance of the electrochemical energy source can also be predetermined in a relatively accurate manner. In this context it is noted that a surface of the substrate onto which the stack is deposited may be either substantially flat or may be patterned (by curving the substrate and/or providing the substrate with trenches, holes and/or pillars) to facilitate generating a three-dimensional oriented cell.

The electrochemical energy source preferably comprises at least one barrier layer being deposited between the substrate and at least one electrode, which barrier layer is adapted to at least substantially preclude diffusion of active species of the cell into said substrate. In this manner the substrate and the electrochemical cell will be separated chemically, as a result of which the performance of the electrochemical cell can be maintained relatively long-lastingly. In case a lithium ion based cell is applied, the barrier layer is preferably made of at least one of the following materials: Ta, TaN, Ti, and TiN. It may be clear that also other suitable materials may be used to act as barrier layer.

In a preferred embodiment preferably a substrate is applied, which is ideally suitable to be subjected to a surface treatment to pattern the substrate, which may facilitate patterning of the electrode(s). The substrate is more preferably made of at least one of the following materials: C, Si, Sn, Ti, Ge, Al, Cu, Ta, and Pb. A combination of these materials may also be used to form the substrate(s). Preferably, n-type or p-type doped Si or Ge is used as substrate, or a doped Si-related and/or Ge-related compound, like SiGe or SiGeC. As mentioned afore, beside relatively rigid materials, also substantially flexible materials, such as e.g. foils like Kapton® foil, may be used for the manufacturing of the substrate. It may be clear that also other suitable materials may be used as a substrate material.

The invention also relates to an electronic device provided with at least one electrochemical energy source according to the invention, and at least one electronic component connected to said electrochemical energy source. The at least one electronic component is preferably at least partially embedded in the substrate of the electrochemical energy source. In this manner a System in Package (Sip) may be realized. In a SiP one or multiple electronic components and/or devices, such as integrated circuits (ICs), actuators, sensors, receivers, transmitters, et cetera, are embedded at least partially in the substrate of the electrochemical energy source according to the invention. The electrochemical energy source according to the invention is ideally suitable to provide power to relatively small high power electronic applications, such as (bio)implantantables, hearing aids, autonomous network devices, and nerve and muscle stimulation devices, and moreover to flexible electronic devices, such as textile electronics, washable electronics, applications requiring pre-shaped batteries, e-paper and a host of portable electronic applications.

### BRIEF DESCRIPTION OF THE DRAWINGS

The invention is illustrated by way of the following non-limitative examples, wherein:

FIG. 1 shows an electrochemical energy source according to the invention, and

FIGS. 2a-2d shows the manufacturing of another electrochemical energy source according to the invention.

### DETAILED DESCRIPTION OF THE EMBODIMENTS

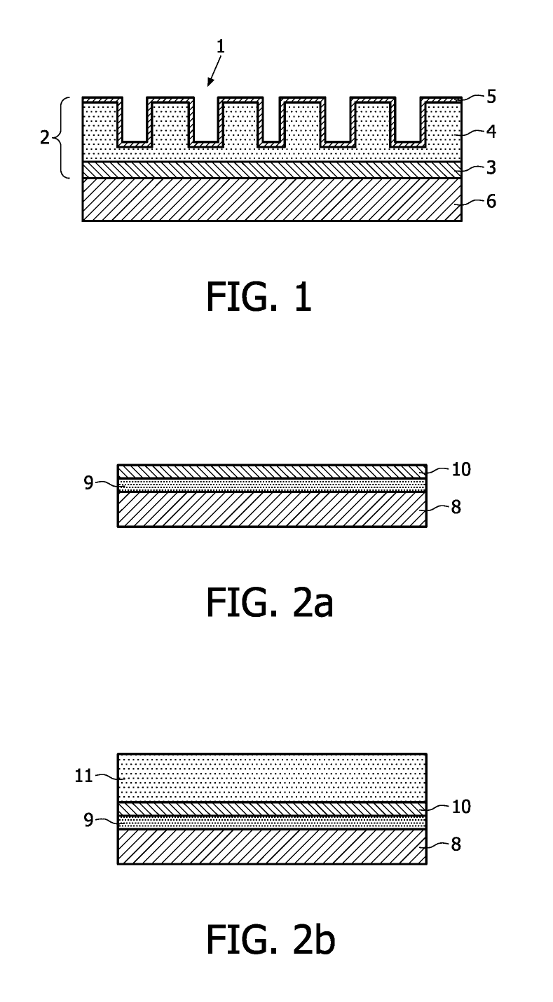

FIG. 1 shows an electrochemical energy source 1 according to the invention, comprising a lithium ion battery stack 2 of an cathode 3, a solid-state electrolyte 4, and an anode 5, which battery stack 2 is deposited onto a conductive substrate 6 in which one or more electronic components may be embedded. In this example the substrate 6 is made of doped silicon, while the anode 5 is made of amorphous silicon (a-Si). The cathode 3 is made of LiCoO₂, and a Garnet-type electrolyte 4 is used. In case lithium ions would leave the stack 2 and would enter the substrate 6 the performance of the stack 2 would be affected. Moreover, this diffusion would seriously affect the electronic component(s) embedded within the substrate 6. In this example, both the cathode 3 and the anode 5 are provided with a current collector (not shown), which may be made of aluminium. To increase the volumetric energy density and hence the performance of the energy source 1, the contact surface area between the electrolyte 4 and the anode 5 has been increased by patterning an upper surface of the electrolyte 4 facing the anode 5, prior to deposition of the anode 5. Deposition of the individual layers 3, 4, 5 can be achieved, for example, by means of CVD, sputtering, E-beam deposition or sol-gel deposition. Patterning the electrolyte 4 may be realised e.g. by wet chemical etching (acid-based), physical etching (Reactive Ion Etching), mechanical imprinting, and chemical mechanical polishing (CMP).

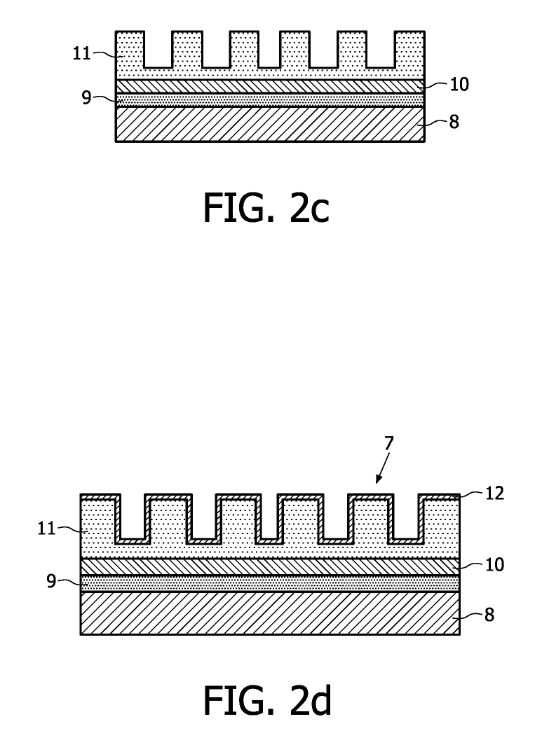

FIGS. 2a-2d shows the manufacturing of another electrochemical energy source 7 according to the invention. The energy source 7 comprises a substrate 8 on top of which a lithium barrier layer 9 is deposited. In this example, the lithium diffusion barrier layer 9 is made of tantalum. On top of the barrier layer 9 an anode 10 and a first current collector (not shown) have been deposited (see FIG. 2a). The conductive tantalum layer 9 acts as a chemical barrier, since this layer counteracts diffusion of lithium ions (or other active species) initially contained by the anode 10 into the substrate 8. Subsequently, on top of the anode 10 a solid-state electrolyte 11 is deposited (see FIG. 2b), after which the electrolyte 11 is textured (patterned) by means of etching techniques as set out above. After texturing the electrolyte 11 the electrochemical energy source 1 is completed by depositing a cathode 12 and a second current collector (not shown) on top of the electrolyte 11.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1. Electrochemical energy source, comprising:
at least one cell is deposited onto a substrate, each cell comprising:
a first electrode,
a solid-state electrolyte deposited onto the first electrode, and
a second electrode deposited onto the solid-state electrolyte;
wherein at least a surface of the solid-state electrolyte facing the second electrode is patterned at least partially.

2. Electrochemical energy source according to claim 1, characterized in that the first electrode comprises a cathode, and/or that the second electrode comprises an anode.

3. Electrochemical energy source according to claim 1, characterized in that the at least a surface of the first electrode facing the electrolyte is provided with at least one cavity.

4. Electrochemical energy source according to claim 3, characterized in that at least a part of the at least one cavity form pillars, trenches, slits, or holes.

5. Electrochemical energy source according to claim 1, characterized in that a surface of the solid-state electrolyte facing the first electrode is substantially flat.

6. Electrochemical energy source according to claim 1, characterized in that at least one electrode is of the cell is provided with at least one patterned surface.

7. Electrochemical energy source according to claim 6, characterized in that the at least one patterned surface of the at least one electrode is provided with multiple cavities.

8. Electrochemical energy source according to claim 7, characterized in that at least a part of the cavities form pillars, trenches, slits, or holes.

9. Electrochemical energy source according to claim 1, characterized in that the solid-state electrolyte is made of at least one material selected from the group consisting of: Li₅La₃Ta₂O₁₂ (Garnet-type class), LiPON, LiNbO₃, LiTaO₃, and Li₉SiAlO₈, Li₂WO₄, LiGeON, Li₁₄ZnGe₄O₁₆(lisicon), Li₃N, beta-aluminas, Li_{1.3}Ti_{1.7}Al_{0.3}(PO₄)₃ (nasicon-type), TiO(OH), and ZrO₂Hₓ.

10. Electrochemical energy source according to claim 2, characterized in that both the anode and the cathode are adapted for storage of active species of at least one of following elements: H, Li, Be, Mg, Cu, Ag, Na and K.

11. Electrochemical energy source according to claim 2, characterized in that at least one of the anode and the cathode is made of at least one of the following materials: C, Sn, Ge, Pb, Zn, Bi, Li, Sb, and, preferably doped, Si.

12. Electrochemical energy source according to claim 1, characterized in that the first electrode and the second electrode each comprises a current collector.

13. Electrochemical energy source according to one claim 12, characterized in that the at least one current collector is made of at least one of the following materials: Al, Ni, Pt, Au, Ag, Cu, Ta, Ti, TaN, and TiN.

14. Electrochemical energy source according to claim 1, characterized in that the energy source further comprises at least one electron-conductive barrier layer being deposited between the substrate and at least one electrode, which barrier layer is adapted to at least substantially preclude diffusion of active species of the cell into said substrate.

15. Electrochemical energy source according to claim 14, characterized in that the at least one barrier layer is made of at least one of the following materials: Ta, TaN, Ti, and TiN.

16. Electrochemical energy source according to claim 1, characterized in that the substrate comprises at least one of the following materials: C, Si, Sn, Ti, Ge, Al, Cu, Ta, and Pb.

17. Electrochemical energy source according to claim 1, characterized in that the substrate is made of a flexible material.

18. Electronic device, comprising at least one electrochemical energy source according to claim 1, and at least electronic component connected to said electrochemical energy source.

19. Electronic device according to claim 18, characterized in that the at least one electronic component is at least partially embedded in the substrate of the electrochemical energy source.

20. Electronic device according to claim 18, characterized in that the at least one electronic component is chosen from the group consisting of: sensing means, pain relief stimulating means, communication means, and actuating means.

21. Electronic device according to claim 18, characterized in that the electronic device and the electrochemical energy source form a System in Package (SiP).
